(19) United States
(12) Patent Application Publication
(10) Pub. No.: US 2010/0012882 A1
(43) Pub. Date: Jan. 21, 2010

(54) REFRIGERANT COMPOSITIONS INCLUDING SILYL TERMINATED POLYALKYLENE GLYCOLS AS LUBRICANTS AND METHODS FOR MAKING THE SAME

(76) Inventors: John W. Sherman, Houston, TX (US); Oscar D. Redwine, Coleman, MI (US); Myrna Serrano, Midland, MI (US); Adam M. Johns, Lake Jackson, TX (US)

Correspondence Address: The Dow Chemical Company;Rader, Fishman & Grauer PLLC, 39533 Woodward Avenue, Suite 140, Bloomfield Hills, MI, 48304, US

(21) Appl. No.: 12/421,248

(22) Filed: Apr. 9, 2009

Related U.S. Application Data
(60) Provisional application No. 61/081,301, filed on Jul. 16, 2008.

(51) Int. Cl. C09K 5/06; C08G 77/02

(52) U.S. Cl. 252/68; 528/29

(57) ABSTRACT

Silyl terminated polyalkylene glycol lubricants for devices that provide cooling or refrigeration, refrigerant compositions including silyl terminated polyalkylene glycol lubricants, and methods for making the same. The lubricant is compatible with hydrofluorocarbon refrigerants such as hydrofluoroolefins (“HFO”), R-134(a), R-152(a), and carbon dioxide.

### CROSS-REFERENCE TO RELATED APPLICATIONS

This application claims the benefit of U.S. Provisional Application No. 61/081,301, filed on Jul. 16, 2008, the entire contents of which are hereby incorporated by reference.

### TECHNICAL FIELD

This disclosure relates to improved lubricant compositions which are especially suited for use in devices that provide cooling or refrigeration, refrigerants that include the improved lubricant, and methods to prepare improved lubricant compositions for use in devices that provide cooling or refrigeration.

There are further disclosed novel silyl terminated polyalkylene glycols that resist water absorption for use as a lubricant in devices that provide cooling or refrigeration, refrigerants that include the novel silyl terminated polyalkylene glycols as lubricants, and methods to prepare silyl terminated polyalkylene glycols for use as lubricants in devices that provide cooling or refrigeration.

There is a continuing need for a refrigerant lubricant that is compatible with both older refrigerants, such as R-134(a), and newer refrigerants, such as R-152(a) and hydrofluoroolefins.

### BACKGROUND

In a response to environmental concerns and new regulations on refrigerant compositions used in the refrigeration and air conditioning industry, new refrigerant compositions are being developed. The environmental friendliness of refrigerants is often characterized by one or both of a criteria known as “global warming potential (GWP)”, or a criteria known as “ozone depletion potential (ODP)”.

The GWP value is a number established by the Intergovernmental Panel on Climate Change (IPCC) that refers to the amount of global warming caused by a substance. The ODP value is a number defined by the United States Environmental Protection Agency that refers to the amount of ozone depletion caused by a substance as compared to chlorofluorocarbon-11 (CFC0911, chemically known as trichlorofluoromethane), as given in 42 U.S.C. 7671, “(10) Ozone-Depletion Potential”, incorporated by reference.

By way of illustration of the progress made thus far, the quest for more environmentally friendly refrigerants was pursued in earnest in the 1980's in response to theories about the depletion of atmospheric ozone due in part to refrigerants such as R-12 (dichlorodifluoromethane), which has a GWP of about 1600 and an ODP of 1. In the 1990's, refrigerants having lower ozone depletion potential, such as R-134a (1,1,1,2-Tetrafluoroethane, also called tetrafluoroethane or HFC-134(a)), were introduced. R-134a has an ODP of zero, but still has a GWP of about 1200. In the late 1980's to early 1990's the refrigeration and air conditioning industries switched refrigerants from R-12 (CFC-12) to R-134(a) due to the latter's zero ozone-depletion-potential. The mineral oil lubricants employed with R-12 were not soluble in R-134(a). Difluoroethane or R-152(a) is another alternative refrigerant. It has a zero ozone deletion potential and its GWP is much lower than that of R-134(a) which makes it attractive. More recently, unsaturated fluorocarbon refrigerants such as hydrofluoroolefins (HFOs) have been proposed due to their superior GWP, which in many cases is less than 150 or lower.

The introduction of the new refrigerants described above required the development of more polar lubricants. For example, Singh, U.S. Pat. No. 7,279,451 and Thomas, U.S. Patent Application Publication No. 2008/0111100 disclose the use of HFO refrigerants with polyalkylene glycol (PAG) lubricants. However, many of the newer refrigerants are less tolerant to the presence of even small amounts of water that are sometimes present in PAG lubricants, due to their affinity for atmospheric water. To address this issue, many current PAG preparation processes utilize water removal processing steps, such as vacuum drying and/or contact with an absorbent material such as silica gel, activated alumina, zeolites, etc. Such processes can be time consuming and/or costly. In addition, water that is not removed from the PAG prior to the PAG's introduction into a refrigeration or air conditioning system can corrode components such as compressors, evaporators, condensers, etc. Also, many known PAG lubricants suffer from poor miscibility in the newer low GWP refrigerants.

There is a continuing need for a PAG lubricant suitable for use with low GWP refrigerants such as R-134(a), R-152(a), and HFOs.

### SUMMARY

In accordance with one aspect, a silyl terminated polyalkylene glycol compound that resists water absorption is provided. The silyl terminated polyalkylene glycol has a number average molecular weight ranging from about 500 to about 4000. The compound is preferably suitable for use a compressor lubricant and miscible in hydrofluorocarbon refrigerants selected from the group consisting of R-134(a), R-152(a) and hydrofluoroolefins. In certain illustrative embodiments, the silyl end group terminating the polyalkylene glycol includes a plurality of hydrocarbyl groups. In other illustrative embodiments, at least one of the hydrocarbyl groups includes a substituent that improves the lubricant's miscibility in the refrigerant.

In accordance with another aspect, a method of preparing a silyl terminated polyalkylene glycol lubricant is provided which comprises reacting a suitable polyalkylene glycol with a silyl hydrocarbyl amine in a suitable solvent and for a sufficient period of time to produce a silyl terminated polyalkylene glycol.

In accordance with a further aspect, there is disclosed a refrigerant composition comprising a refrigerant and a silyl terminated polyalkylene glycol lubricant. In certain illustrative embodiments, the refrigerant has a GWP of less than about 150. In other illustrative embodiments, the lubricant is preferably miscible in the refrigerant at temperatures greater than about −60° C., more preferably greater than about −50° C., and most preferably greater than about −40° C. The lubricant is preferably miscible in the refrigerant at temperatures less than about 60° C., more preferably less than about 50° C., and most preferably less than about 40° C.

### DETAILED DESCRIPTION OF THE PREFERRED EMBODIMENT(S)

This disclosure relates to improved lubricants and a method of making lubricants which are especially suited for use in cooling and/or refrigeration systems. As described in greater detail below, the lubricants described herein comprise polyalkylene glycols with one or more silyl end groups.

The lubricant composition may be used a variety of lubricating applications, including without limitation, engines and stationary or mobile refrigeration/cooling systems. In this regard, it is contemplated that the lubricant is useful, with the suitable refrigerant, in vehicle air conditioning, commercial, industrial or residential buildings having air conditioning. Moreover, it is contemplated that refrigerators, and freezers, either stationary or mobile, may be suitable for use with the lubricants. In a preferred embodiment, the lubricants are combined with a refrigerant used in a vehicle air conditioning system or other portable cooling system. The lubricant is miscible with a suitable refrigerant at concentrations sufficient to impart lubricating properties to the refrigerant/lubricant mixtures such that compressor components in a refrigeration/cooling device are lubricated during use.

Suitable refrigerants include one or more hydrofluorocarbons, such as CH₃CHF₂, C₂HF₅, CH₂2F₂, C₂H₃F₃, CHF₃ and C₂H₂F₄ which are commonly known as R-152(a), R-125, R-32, R-143(a), R-23 and R-134(a), respectively. Carbon dioxide is also a suitable refrigerant. Hydrocarbons, such as propane and butane, may be used as secondary refrigerants that are used in combination with hydrofluorocarbon refrigerants.

Additional suitable refrigerants include hydrofluoroolefins (HFO). For heat transfer applications such as automotive air conditioning systems, C₂-C₅ HFOs are preferred, with C₂-C₄ HFOs being more preferred, and C₃-C₄ being most preferred. C₃-C₄ HFOs with at least two and preferably at least three fluorine substituents are especially preferred. Suitable HFOs include without limitation the following: 1,2,3,3,3-pentafluoro-1-propene, 1,1,3,3,3-pentafluoro-1-propene, 1,1,2,3,3-pentafluoro-1-propene, 1,2,3,3-tetrafluoro-1-propene, 2,3,3,3-tetrafluoro-1-propene, 1,3,3,3-tetrafluoro-1-propene, 1,1,2,3-tetrafluoro-1-propene, 1,1,3,3-tetrafluoro-1-propene, 1,2,3,3-tetrafluoro-1-propene, 2,3,3-trifluoro-1-propene, 3,3,3-trifluoro-1-propene, 1,1,2-trifluoro-1-propene, 1,1,3-trifluoro-1-propene, 1,2,3-trifluoro-1-propene, 1,3,3-trifluoro-1-propene, 1,1,1,2,3,4,4,4-octafluoro-2-butene, 1,1,2,3,3,4,4,4-octafluoro-1-butene, 1,1,1,2,4,4,4-heptafluoro-2-butene, 1,2,3,3,4,4,4-heptafluoro-1-butene, 1,1,1,2,3,4,4-heptafluoro-2-butene, 1,3,3,3-tetrafluoro-2-(trifluoromethyl)-2-propene, 1,1,3,3,4,4,4-heptafluoro-1-butene, 1,1,2,3,4,4,4-heptafluoro-1-butene, 1,1,2,3,3,4,4-heptafluoro-1-butene, 2,3,3,4,4,4-hexafluoro-1-butene, 1,1,1,4,4,4-hexafluoro-2-butene, 1,3,3,4,4,4-hexafluoro-1-butene, 1,2,3,4,4,4-hexafluoro-1-butene, 1,2,3,3,4,4-hexafluoro-1-butene 1,1,2,3,4,4-hexafluoro-2-butene, 1,1,1,2,3,4-hexafluoro-2-butene, 1,1,1,2,3,3-hexafluoro-2-butene, 1,1,1,3,4,4-hexafluoro-2-butene, 1,1,2,3,3,4-hexafluoro-1-butene, 1,1,2,3,4,4-hexafluoro-1-butene, 3,3,3-trifluoro-2-(trifluoromethyl)-1-propene, 1,1,1,2,4-pentafluoro-2-butene, 1,1,1,3,4-pentafluoro-2-butene, 3,3,4,4,4-pentafluoro-1-butene, 1,1,1,4,4-pentafluoro-2-butene, 1,1,1,2,3-pentafluoro-2-butene, 2,3,3,4,4-pentafluoro-1-butene, 1,1,2,4,4-pentafluoro-2-butene, 1,1,2,3,3-pentafluoro-1-butene, 1,1,2,3,4-pentafluoro-2-butene, 1,2,3,3,4-pentafluoro-1-butene, 1,1,3,3,3-pentafluoro-2-methyl-1-propene, 2-(difluoromethyl)-3,3,3-trifluoro-1-propene, 3,3,4,4-tetrafluoro-1-butene, 1,1,3,3-tetrafluoro-2-methyl-1-propene, 1,3,3,3-tetrafluoro-2-methyl-1-propene, 2-(difluoromethyl)-3,3-difluoro-1-propene, 1,1,1,2-tetrafluoro-2-butene, 1,1,1,3-tetrafluoro-2-butene, 1,1,1,2,3,4,4,5,5,5-decafluoro-2-pentene, 1,1,2,3,3,4,4,5,5,5-decafluoro-1-pentene, 1,1,1,4,4,4-hexafluoro-2-(trifluoromethyl)-2-butene, 1,1,1,2,4,4,5,5,5-nonafluoro-2-pentene, 1,1,1,3,4,4,5,5,5-nonafluoro-2-pentene, 1,2,3,3,4,4,5,5,5-nonafluoro-1-pentene, 1,1,3,3,4,4,5,5,5-nonafluoro-1-pentene, 1,1,2,3,3,4,4,5,5-nonafluoro-1-pentene, 1,1,2,3,4,4,5,5,5-nonafluoro-2-pentene, 1,1,1,12,3,4,4,5,5-nonafluoro-2-pentene, 1,1,1,2,3,4,5,5,5-nonafluoro-2-pentene, 1,2,3,4,4,4-hexafluoro-3-(trifluoromethyl)-1-butene, 1,1,2,4,4,4-hexafluoro-3-(trifluoromethyl)-1-butene, 1,1,1,4,4,4-hexafluoro-3-(trifluoromethyl)-2-butene, 1,1,3,4,4,4-hexafluoro-3-(trifluoromethyl)-1-butene, 2,3,3,4,4,5,5,5-octafluoro-1-pentene, 1,2,3,3,4,4,5,5-octafluoro-1-pentene, 3,3,4,4,4-pentafluoro-2-(trifluoromethyl)-1-butene, 1,1,4,4,4-pentafluoro-3-(trifluoromethyl)-1-butene, 1,3,4,4,4-pentafluoro-3-(trifluoromethyl)-1-butene, 1,1,4,4,4-pentafluoro-2-(trifluoromethyl)-1-butene, 1,1,1,4,4,5,5,5-octafluoro-2-pentene, 3,4,4,4-tetrafluoro-3-(trifluoromethyl)-1-butene, 3,3,4,4,5,5,5-heptafluoro-1-pentene, 2,3,3,4,4,5,5-heptafluoro-1-pentene, 1,1,3,3,5,5,5-heptafluoro-1-pentene, 1,1,1,2,4,4,4-heptafluoro-3-methyl-2-butene, 2,4,4,4-tetrafluoro-3-(trifluoromethyl)-1-butene, 1,4,4,4-tetrafluoro-3-(trifluoromethyl)-1-butene, 1,4,4,4-tetrafluoro-3-(trifluoromethyl)-2-butene, 2,4,4,4-tetrafluoro-3-(trifluoromethyl)-2-butene, 3-(trifluoromethyl)-4,4,4-trifluoro-2-butene, 3,4,4,5,5,5-hexafluoro-2-pentene, 1,1,1,4,4,4-hexafluoro-2-methyl-2-butene, 3,3,4,5,5,5-hexafluoro-1-pentene, 4,4,4-trifluoro-2-(trifluoromethyl)-1-butene, 1,1,2,3,3,4,4,5,5,6,6,6-dodecafluoro-1-hexene, 1,1,1,2,2,3,4,5,5,6,6,6-dodecafluoro-3-hexene, 1,1,1,4,4,4-hexafluoro-2,3-bis(trifluoromethyl)-2-butene, 1,1,1,4,4,5,5,5-octafluoro-2-trifluoromethyl-2-pentene, 1,1,1,3,4,5,5,5-octafluoro-4-(trifluoromethyl)-2-pentene, 1,1,1,4,5,5, 5-heptafluoro-4-(trifluoromethyl)-2-pentene, 1,1,1,4,4,5,5,6,6,6-decafluoro-2-hexene, 1,1,1,2,2,5,5,6,6,6-decafluoro-3-hexene, 3,3,4,4,5,5,6,6,6-nonafluoro-1-hexene, 4,4,4-trifluoro-3,3-bis(trifluoromethyl)-1-butene, 1,1,1,4,4,4-hexafluoro-3-methyl-2-(trifluoromethyl)-2-butene, 2,3,3,5,5,5-hexafluoro-4-(trifluoromethyl)-1-pentene, 1,1,1,2,4,4,5,5,5-nonafluoro-3-methyl-2-pentene, 1,1,1,5,5,5-hexafluoro-4-(trifluoromethyl)-2-pentene, 3,4,4,5,5,6,6,6-octafluoro-2-hexene, 3,3,4,4,5,5,6,6-octafluoro-2-hexene, 1,1,1,4,4-pentafluoro-2-(trifluoromethyl)-2-pentene, 4,4,5,5,5-pentafluoro-2-(trifluoromethyl)-1-pentene, 3,3,4,4,5,5,5-heptafluoro-2-methyl-1-pentene, 1,1,1,2,3,4,4,5,5,6,6,7,7,7-tetradecafluoro-2-heptene, 1,1,1,2,2,3,4,5,5,6,6,7,7,7-tetradecafluoro-2-heptene, 1,1,1,3,4,4,5,5,6,6,7,7,7-tridecafluoro-2-heptene, 1,1,1,2,4,4,5,5,6,6,7,7,7-tridecafluoro-2-heptene, 1,1,1,2,2,4,5,5,6,6,7,7,7-tridecafluoro-3-heptene, 1,1,1,2,2,3,5,5,6,6,7,7,7-tridecafluoro-3-heptene, 4,4,5,5,6,6,6-heptafluoro-2-hexene, 4,4,5,5,6,6,6-heptafluoro-1-hexene, 1,1,1,2,2,3,4-heptafluoro-3-hexene, 4,5,5,5-tetrafluoro-4-(trifluoromethyl)-1-pentene, 1,1,1,2,5,5,5-heptafluoro-4-methyl-2-pentene, 1,1,1,3-tetrafluoro-2-(trifluoromethyl)-2-pentene, 1,2,3,3,4,4-hexafluorocyclobutene, 3,3,4,4-tetrafluorocyclobutene, 3,3,4,4,5,5-hexafluorocyclopentene, 1,2,3,3,4,4,5,5-octafluorocyclopentene, 1,2,3,3,4,4,5,5,6,6-decafluorocyclohexene, 1,1,1,2,3,4,5,5,5-nonafluoro-4-(trifluoromethyl)-2-pentene, pentafluoroethyl trifluorovinyl ether, trifluoromethyl trifluorovinyl ether; or any combination thereof.

The lubricant may be one or more polar, oxygenated compounds including polyalkylene oxides also known as polyalkylene glycols (PAGs) with one or more silyl group end caps on one or more ends thereof. The silyl end group preferably includes a plurality of hydrocarbyl groups and most preferably includes three hydrocarbyl groups. In certain preferred embodiments, the silyl end cap reduces the affinity of the lubricant for water, thereby minimizing or eliminating the need for water removal processes such as vacuum drying, or contacting the lubricant with water absorbent materials such as silica gel, activated alumina, zeolites, etc. The silyl end caps may also protect the PAG against degradation by some acids and improve the PAG's viscosity index. For automotive compressor applications, preferred PAG lubricants include monols that have at least a single hydroxyl group. However, polyhydric PAGs such as diols and triols may also be suitable. Furthermore, for such applications, propylene oxide PAG hompolymers are preferred, and propylene oxide homopolymers initiated with mono and polyhydric alcohols are more preferred, for example, those initiated with methanol, butanol and glycerin.

In one embodiment, there is disclosed a silyl terminated polyalkylene glycol refrigerant lubricant compound having the formula:

R₅—(O—(PO)ₘ(EO)ₙSiR₁R₂R₃)ₓ (1)
wherein
PO is a propylene oxide unit (—CH₂—(CH₃)CH₂—O—);
EO is ethylene oxide unit (—CH₂—CH₂—O—);
R₁, R₂, and R₃ are the same or different and are selected from the group consisting of alkyl, aryl, substituted alkyl, substituted aryl, functionalized alkyl, functionalized aryl, and combinations thereof;
x is at least 1;
R₅ is an x valent hydrocarbyl group;
m is a number of at least 0;
n is a number at of least 0; and
m+n is greater than 0.

The term “x valent” means that R₅ has x valence electrons available for bonding with each of the x PAG chains in the lubricant compound. The numerical value of x is preferably greater than 1, more preferably from 1 to 6, even more preferably from 1 to 4, and most preferably from 1 to 2. For commercial compressor lubricants, x is preferably 1 or 2 and is most preferably 2.

As indicated above, R₁, R₂, and R₃ are the same or different and are selected from the group consisting of alkyl, aryl, substituted alkyl and combinations thereof. R₁, R₂, and R₃ preferably comprise 1-30 carbons, more preferably from 1-25 carbons, and most preferably from 1-20 carbons. R₁, R₂, and R₃ may be straight chain or branched. Exemplary substituted alkyls and aryls include those that are halogenated or partially halogenated. Exemplary aryls include without limitation phenyl, substituted phenyls, naphthyl, substituted naphthyls, and combinations thereof. Exemplary hydrocarbyls include without limitation methyl, ethyl, n-propyl, iso-propyl, tert-butyl, benzyl, and combinations thereof. Exemplary substituted alkyls include fluorinated alkyls, chlorinated alkyls, ethers, thioethers, tertiary amines, and combinations thereof.

Any or all of R₁, R₂, and R₃ may be substituted or functionalized in a manner that promotes the solubility of the end-capped PAG lubricant in the refrigerant. For example, where a fluorinated refrigerant is used, the PAG lubricant may include a silyl end cap with one or more fluoro-substituted hydrocarbyl groups. In an especially preferred embodiment of a hydrofluorocarbon refrigerant composition, at least one of R₁, R₂, and R₃ is a fluoro hydrocarbyl, which improves the miscibility of the lubricant in a fluorocarbon refrigerant. In one embodiment of the refrigerant composition, at least one of the R₁, R₂ and R₃ groups of a suitable lubricant may be a fluorinated alkyl. Suitable fluorinated alkyls may be selected from the group consisting of 3,3,3-trifluoropropyl, tridecafluoropropyl-1,1,2,2-tetrahydrooctyl, heptadecafluoro-1,1,2,2-tetrahydrodecyl, nonafluorohexyl, and combinations thereof. One exemplary fluorinated alkyl group is a 3,3,4,4,5,5,6,6,7,7,8,8,8,-tridecafluoroctyl group. In one example, R₁ and R₂ are methyl groups and R₃ is a 3,3,4,4,5,5,6,6,7,7,8,8,8,-tridecafluoroctyl group.

R₅ is an x valent hydrocarbyl group, and is preferably a residue of a compound having x active hydroxyl groups. It preferably has from 1 to 30 carbons and is selected from the group consisting of hydrogen, an alkyl, an aryl, and a fully or partially halogenated alkyl or aryl. R₅ more preferably has from 1 to 25 carbons and most preferably has from 1 to 20 carbons.

In the case where R₁, R₂, or R₃ is a substituted alkyl, preferably, at least one of R₁, R₂ and R₃ of the silyl terminated polyalkylene glycol refrigerant lubricant is a fluorinated alkyl, and R₅ is an alkyl or hydrogen.

In the case of n=0 and m>0, the compound of formula (1) is a homopolymer of propylene oxide, and in the case of n>0 and m=0 the compound is a homopolymer of ethylene oxide. In the case of PAG homopolymers, propylene oxide homopolymers are preferred. Exemplary propylene oxide homopolymer precursors (i.e., before end-capping) include UCON® materials supplied by Dow Chemical Company under the trade names LB-65, LB-165, LB-285, LB-385, and LB-525.

In the case of n>0 and m>0, the compound of formula (1) is a random or block copolymer of ethylene oxide and propylene oxide. Preferred random copolymers comprise polymers of ethylene oxide EO and PO in a ratio of EO to EO+PO (i.e., n/(m+n)) of between about 0.01 to about 0.75 initiated with mono and polyhydric alcohols such as methanol, butanol and glycerin. More preferred ratios include ratios incremented by about 0.05 between about 0.1 and 0.7, with most preferred ratio including those incremented by about 0.1 between about 0.1 and about 0.7 (e.g. 0.1, 0.2, 0.3, 0.4, 0.5, 0.6 and 0.7). Stated alternatively, on a weight basis, the PAGs preferably contain greater than about 5% EO, and correspondingly less than about 95% PO. More preferably, the PAGs contain greater than about 25% EO and correspondingly less than about 75% PO. Even more preferably, the PAGs contain greater than about 40% EO and less than about 60% PO. The PAGs preferably contain less than about 95% EO and correspondingly greater than about 5% PO, more preferably less than about 75% EO and greater than about 25% PO, and most preferably less than about 60% EO and correspondingly greater than about 40% PO. Most preferably, the PAGs contain about 50% EO and about 50% PO. One suitable random copolymer of EO and PO is UCON® RL-488, which has a ratio of ethylene oxide units to propylene oxide units (e.g., n/m in formula (1)) of about 1. RL-488 has a viscosity of about 135 cSt at 40° C. and a viscosity of about 125 cSt at 100° C.

The silyl end capped polyalkylene glycol lubricants preferably have a number average molecular weight as measured by Gel Permeation Chromatography (GPC) or Time of Flight Mass Spectrometry (TOF-MS) that provides Falex wear load to failure wear testing results (as measured by the ASTM D-3233 Extreme Pressure procedure) which are preferably at least about 1000 lbs, more preferably at least about 1500 lbs., even more preferably at least about 2000 lbs. and most preferably at least about 3000 lbs. Number average molecular weights of at least about 500 are preferred, with molecular weights of at least about 700 being more preferred and molecular weights of at least about 800 being even more preferred. Number average molecular weights of at least about 1000 are most preferred. Number average molecular weights of not more than about 4000 are preferred, with molecular weights of not more than about 3,000 being more preferred and not more than about 2000 being even more preferred. Number average molecular weights of not more than 1100 are most preferred.

The lubricants are selected to have a viscosity that provides a balance between energy consumption (i.e., hydraulic energy expended in the flow of the lubricant through the refrigeration system) and lubricity. More viscous lubricants tend to provide greater lubricity but require more hydraulic energy. The lubricants described herein have a viscosity at 40° C. that is preferably greater than about 10 cSt, more preferably greater than about 22 cSt and most preferably greater than about 40 cSt. Lubricant viscosities (at 40° C.) of less than about 460 cSt are preferred, viscosities of less than about 220 cSt are more preferred, and viscosities of less than about 150 cSt are most preferred.

As is known in the art, the “viscosity index” is a measure of the temperature sensitivity of a material's viscosity. The lubricants described herein have a viscosity index (as measured by ASTM D2270) that is preferably at least about 190, more preferably at least about 200, and most preferably at least about 210.

A standard test used by the industry for evaluation of thermal stability is the Sealed Tube Stability Test (originally ASHRAE 97-83, now 97-99). In this test, refrigerant and lubricant are sealed into an evacuated glass tube containing samples of selected metals—usually copper, steel, and aluminum alloys—immersed in the liquid. The tube is then maintained at 175° C. for 14 days, cooled, and the contents removed for analysis. The refrigerant is analyzed by gas chromatography for degradation; the lubricating oil is analyzed for changes in acid number and the presence of metals; and the metal samples are evaluated for corrosion. This accelerated test simulates the interaction between the lubricant and the refrigerant in the presence of the mixed metals of construction. A good refrigeration lubricant will not cause degradation of the refrigerant or corrosion of the metals. When subjected to the ASHRAE 97-99 test, the lubricants described herein preferably exhibit a change in total acid number of less than about 3.5, more preferably less than about 3.3, even more preferably less than about 2.0, and most preferably less than about 1.0.

In certain exemplary embodiments, for example, automotive air conditioning applications, a refrigerant composition is provided which comprises a silyl end capped polyalkylene glycol lubricant and a refrigerant, such as the hydrofluorocarbon refrigerants discussed above. In such embodiments, the lubricant should have sufficient solubility in the refrigerant to insure that the lubricant can return to the compressor from the evaporator. Furthermore, the refrigerant and lubricant composition should have a low temperature viscosity that allows the lubricant to pass through the cold evaporator. In one preferred embodiment, the refrigerant and the lubricant are miscible over a broad range of temperatures. The lubricant is soluble in the refrigerant at temperatures that are preferably greater than about −60° C., more preferably greater than about −50° C., and most preferably greater than about −40° C. The lubricant is soluble in the refrigerant at temperatures that are preferably less than about 60° C., more preferably less than about 50° C., and most preferably less than about 40° C.

In accordance with the foregoing exemplary embodiment, generally the amount of lubricant in the refrigerant composition is sufficient to lubricate the compressor. Preferably, greater than about 1% of lubricant compound by weight of the refrigerant composition at the time the composition is charged into a system is used herein. Lubricant amounts of greater than about 2% by weight of the refrigerant composition are more preferred, and lubricant amounts of greater than about 3% by weight are most preferred. Lubricant amounts of less than about 50% by weight of the refrigerant composition are preferred, and lubricant amounts of less than about 40% by weight of the refrigerant composition are more preferred. Lubricant amounts of less than about 30% by weight are most preferred. The amount of the lubricant will typically affect the mutual solubility of the refrigerant and lubricant and thus the available operating temperatures for the refrigeration device.

In another aspect of this disclosure, the solubility of the lubricant in the refrigerant is temperature dependent because the temperature within the compressor is usually significantly higher than the temperature within the evaporator. Preferably, in the compressor, the lubricant and the refrigerant are separate from each other and not soluble; the lubricant is a liquid and the refrigerant is a gas being compressed. On the contrary, in the evaporator, preferably the lubricant and the refrigerant are mutually soluble. This ideal situation would lead to minimal decreases in viscosity of the lubricant in the compressor due minimal dilution by the refrigerant. This in turn leads to better lubricity and decreased lubricant discharge from the compressor. At the same time, the low temperature solubility helps insure that any lubricant that is discharged from the compressor is returned by diluting the cold lubricant and thus keeping its viscosity low. Thus, in one embodiment, a lubricant that exhibits low temperature solubility (i.e., solubility at the evaporator operating temperature) and high temperature insolubility (i.e., insolubility at the compressor operating temperature) is desirable.

The lubricant compounds described herein may also be used to prepare lubricant compositions that include the lubricant compound and an additives package with some or all the following: an extreme pressure additive, an anti-wear additive, an antioxidant, a high-temperature stabilizer, a corrosion inhibitor, a detergent and an anti-foaming agent. Extreme pressure additives improve the lubricity and load bearing characteristics of the refrigerant composition. Preferred additives include those described in U.S. Pat. Nos. 5,152,926; 4,755,316, which are hereby incorporated by reference. In particular, the preferred extreme pressure additives include mixtures of (A) tolyltriazole or substituted derivatives thereof, (B) an amine (e.g. Jeffamine M-600) and (C) a third component which is (i) an ethoxylated phosphate ester (e.g. Antara LP-700 type), or (ii) a phosphate alcohol (e.g. ZELEC 3337 type), or (iii) a zinc dialkyldithiophosphate (e.g. Lubrizol 5139, 5604, 5178, or 5186 type), or (iv) a mercaptobenzothiazole, or (v) a 2,5-dimercapto-1,3,4-triadiazole derivative (e.g. Curvan 826) or a mixture thereof.

The additive package preferably includes a flame retardant that reduces or eliminates the likelihood of the lubricant being the fuel for a fire. Flame retardants may increase the vapor pressure of the composition, increase the flash point of composition, or otherwise reduce the chance of fire. In one embodiment, the flame retardant is a gaseous phase flame retardant (all though not necessarily the case) such that the flame is gaseous when the refrigerant is also gaseous. Suitable flame retardants include trifluorochloromethane, trifluoroiodomethane, phosphorus compounds such as phosphate esters and hydrocarbons, hydrofluorocarbons, or fluorocarbons that also contain iodine and/or bromine.

In another embodiment, the present disclosure relates to a method for preparing a silyl terminated polyalkylene glycol refrigerant lubricant. The method comprises reacting a suitable polyalkylene glycol with a suitable silyl hydrocarbyl amine end cap precursor in the presence of a suitable solvent for a sufficient period of time to produce a silyl terminated polyalkylene glycol lubricant. The silyl hydrocarbyl amine may be reacted with a suitable PAG to produce a silyl terminated PAG with a number average molecular weight that is preferably at least about 500, more preferably at least about 700, even more preferably at least about 800 and most preferably at least about 1,000. The number average molecular weight is preferably no greater than about 4,000, more preferably no greater than about 3,000, even more preferably no greater than about 2,000 and most preferably no greater than about 1,100.

Preferred silyl hydrocarbyl amine end-cap precursors are those having the following formula:

R₁R₂R₃SiN(R₄)₂ (2)
wherein R₁, R₂, R₃ are selected from the group consisting of alkyl, aryl, substituted alkyl, functionalized alkyl, functionalized aryl, and combinations thereof as described above with respect to formula (1); and
R₄ is an alkyl or aryl.

The reaction solvent is a liquid medium that dissolves both the hydrocarbyl silyl amine and the PAG and which has a boiling point that allows it to be readily separated from the silyl terminated PAG reaction product. The boiling point of the solvent is preferably at least about 30° C., more preferably at least about 50° C., even more preferably at least about 60° C., and most preferably at least about 70° C. The solvent boiling point is preferably no greater than about 130° C., more preferably no greater than about 110° C., even more preferably no greater than about 100° C., and most preferably no greater than about 90° C. The solvent is preferably selected from the group consisting of ethers, aliphatic or aromatic hydrocarbons, and combinations thereof. Examples include, toluene, xylene, benzene, hexane, pentane, diethyl ether, and combinations thereof.

In an illustrative embodiment, the reaction between the hydrocarbyl silyl amine and the PAG may be described as follows:

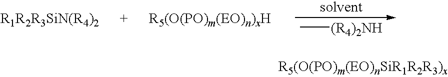

wherein
PO is a propylene oxide unit (—CH₂—(CH₃)CH₂—O—);
EO is an ethylene oxide unit (—CH₂—CH₂—O—);
R₁, R₂,R₃ are selected from the group consisting of alkyl, aryl, substituted alkyl, substituted aryl, functionalized alkyl, functionalized aryl, and combinations thereof as described above with respect to formula (1);
x is a number of at least 1;
R₄ is an alkyl or an aryl;
R₅ is an x valent hydrocarbyl group;
m is a number of at least 0;
n is a number of at least 0; and
m+n is greater than 0.

In a preferred embodiment of the method, the PAG comprises propylene oxide units (i.e., m>0). Preferably, R₄ is a hydrocarbyl group having 1-20 carbons, more preferably 1-15 carbons, and most preferably 1-10 carbons. Especially preferred hydrocarbyl groups are those selected from the group consisting of methyl, ethyl, propyl, butyl, pentyl, octyl, allyl, and benzyl. Suitable hydrocarbyl silyl amine end-cap precursors include N,N-dialkyl(trialkylsilyl) amines such as N,N-diethyltrimethylsilylamine, N,N-dimethyltrimethylsilylamine, dimethyl(dimethylamino)vinylsilane, n-octyidimethyl(dimethylamino)silane, n-butyldimethyl(dimethylamino)silane, (diisopropylamino)trimethylsilane, and combinations thereof. It is preferred to use dialklyamine end-cap precursors with a boiling point similar to that of the solvent and which is preferably at least about 30° C., more preferably at least about 50° C., even more preferably at least about 60° C., and most preferably at least about 70° C. Preferably, the precursor boiling point is no greater than about 130° C., more preferably no greater than bout 110° C., even more preferably no greater than about 100° C., and most preferably no greater than about 90° C.

In the above reaction, the reaction time period ranges from about 6 hours to about 16 hours, and more preferably, from about 12 to about 16 hours. The temperature for the reaction is generally any temperature that is approximately equal to or greater than the boiling point of the solvent used. Generally, the solvent may be any ether, aliphatic or aromatic hydrocarbon. Depending upon the solvent used, the temperature may preferably be greater than about 30° C., with temperatures greater than about 50° C. being more preferred, and temperatures greater than about 60° C. being even more preferred. Temperatures greater than about 70° C. are most preferred. Preferably the reaction temperature is less than about 130° C., more preferably less than about 110° C., and even more preferably less than about 100° C., with reaction temperatures of less than about 90° C. being most preferred. The resulting silyl terminated polyalkylene glycol lubricant may be purified, preferably by devolatizing the solvent. It has been found that a reaction of N,N-dialkyl(trialkylsilyl)amines with the polyalkylene glycol lubricant under the conditions set forth above yields a high yield, high purity silyl terminated polyalkylene glycol lubricant. The yield of end-capped PAG lubricant is preferably greater than about 80%, more preferably greater than about 85%, even more preferably greater than about 95%, and most preferably greater than about 98%. After devolatilization, the purity of the end-capped PAG is preferably greater than about 90%, more preferably greater than about 95%, even more preferably greater than about 98% and most preferably greater than about 99%.

Another method of making a silyl end-capped polyalkylene glycol lubricant will now be described. In accordance with the method, a precursor composition is provided which comprises at least one polyaklylene glycol having at least one hydroxyl end group. In accordance with the method, a hydrocarbyl silyl halide end-cap precursor is provided. The hydrocarbyl silyl halide end-cap precursor is preferably tri-substituted and has the formula R₁R₂R₃SiX, wherein X is a halogen atom, and R₁, R₂, and R₃ are the same or different and are selected from the group consisting of alkyl, aryl, substituted alkyl, substituted aryl, functionalized alkyl, functionalized aryl, and combinations thereof, as described above with respect to formulas (1) and (2).

In a preferred embodiment, the tri-substituted silyl halide is a tri-alkyl silyl halide. In a more preferred embodiment, the tri-substituted silyl halide is trialkyl silyl chloride such as trimethyl silyl chloride ((CH₃)₃SiCl). The trialkyl silyl halide is combined with the precursor composition to form a reaction mixture. In the reaction mixture, the halogenated trialkyl silyl chloride reacts with the PAG hydroxyl group(s) for a time and at a temperature that is sufficient to form hydrogen chloride (HCl) and the end-capped product. The presence of HCl can cause the end-capping reaction to become reversible. Thus, in certain preferred methods, an acid scavenger is combined with the polyalkylene glycol prior to adding the trialkyl silyl halide. The acid scavenger is preferably a tertiary amine or heterocyclic amine (e.g., pyridine, imidazole, triethylamine), but is preferably not a secondary amine. In one preferred embodiment, the acid scavenger is pyridine. The addition of an acid scavenger results in the formation of a salt when combined with the HCl product. In the case of pyridine, pyridinium chloride is obtained. The number of moles of tri-substituted silyl halide is preferably equal to or greater than the number of active hydroxyl groups on the PAG and is more preferably added in a molar excess relative to the PAG to ensure that a desired amount of end-capping is obtained. In certain preferred embodiments, a three-fold excess of trialkyl silyl halide is added. The acid scavenger is preferably added in a molar excess relative to the amount of trialkyl silyl halide. The acid scavenger is preferably provided in an amount that is at least about 1% in excess of the number of moles of the trialkyl silyl halide, more preferably at least about 2%, and most preferably at least about 5%. The excess acid scavenger may be removed by techniques such as devolatilization or extraction.

In certain illustrative examples, the reaction of a trialkyl silyl halide and PAG is carried out in a reaction medium such as an organic solvent. The reaction solvent is a liquid medium that dissolves both the hydrocarbyl silyl halide and the PAG and which has a boiling point that allows it to be readily separated from the silyl terminated PAG reaction product.

The boiling point of the solvent is preferably greater than about 30° C., more preferably greater than about 50° C., and most preferably greater than about 60° C., with solvent boiling points greater than about 70° C. being especially preferred. Preferably the solvent boiling point is less than about 130° C., more preferably less than about 110° C., and most preferably less than about 100° C., with solvent boiling points less than about 90° C. being especially preferred. The solvent is preferably selected from the group consisting of ethers, aliphatic or aromatic hydrocarbons, and combinations thereof. Examples include, toluene, xylene, benzene, hexane, pentane, diethyl ether, and combinations thereof.

In one example, the PAG is diluted to a concentration that is preferably greater than about 30% by weight of the organic solvent before adding the hydrocarbyl silyl halide. More preferably, the diluted PAG concentration is greater than about 40%, and most preferably the diluted PAG concentration is greater than about 45%. The diluted PAG concentration is preferably less than about 70%, more preferably less than about 60% and most preferably less than about 55%.

Combining the hydrocarbyl silyl halide and the PAG forms a reaction mixture that is exothermic. The hydrocarbyl silyl halide may be low boiling (e.g., trimethyl silyl chloride has a boiling point of between 57° C.-59° C.). In order to prevent it from evaporating as the reaction progresses, the exotherm is preferably controlled by cooling the reaction mixture to prevent the temperature from rising more than 40° C., and more preferably, 30° C. After the addition of the hydrocarbyl silyl halide, the reaction product is preferably washed with water to remove HCl. The product is then heated to drive off any residual water. In one preferred embodiment, the residual amount of water is less than 100 ppm of the total amount of lubricant compound and water. Other techniques may also be used to remove residual water, for example, contacting the lubricating composition with anhydrous magnesium sulfate and/or rotary evaporation.

As mentioned above, the amount of hydrocarbyl silyl halide is preferably selected to obtain the desired amount of end capping in the PAG. In preferred embodiments, the percent end-capping is at least about 80 percent. In more preferred embodiments, the percent end-capping is at least about 90 percent, and in an especially preferred embodiment, the percent end-capping is at least about 98 percent, wherein the percent end-capping is determined by dividing the number of moles of O—Si groups divided by the number of moles of O—Si groups plus —OH groups and may be determined using ¹³C NMR spectroscopy.

The following examples illustrate various aspects of the preparation of preferred silyl terminated polyalkylene glycol lubricants contemplated in the present application.

### EXAMPLES

In each of the following examples, UCON LB-285 (available from Dow Chemical Company) is a butanol initiated PO homopolymer with a MW of 1020 g/mol. UCONLB-285 has an OH functionality of 1 (monol) and viscosities of 61 cSt@40° C. and 10.8 cSt@100° C.

### Example 1

Dry UCON LB-285 (100. g, 98.0 mmol) is weighed into an oven-dried 500 mL round bottom flask equipped with a magnetic stirbar. Dry toluene (100 mL) is added under a nitrogen purge and the reaction is equipped with a 125 mL dropping funnel loaded with a solution of trimethylsilyldiethylamine (19.5 mL, 103 mmol) in dry toluene (50 mL). The trimethylsilyldiethylamine solution is added drop wise and the reaction is subsequently fitted with a reflux condenser and heated to 80° C. for 15.5 h. After allowing the reaction to cool to room temperature, all volatiles (toluene, diethylamine, and excess trimethylsilyldiethylamine) are removed by rotary evaporation under high vacuum at an elevated temperature. The resulting product is transferred to a pre-weighed air tight container and padded with nitrogen. The yield is 103.7 g of trimethylsilyl terminated UCON LB-285, which on a percentage basis is 96.8%.

Example 1 illustrates one method to use commercially available reagents to produce a silyl terminated polyalkylene glycol lubricant with a relatively high purity and yield.

### Example 2

Tridecalfuoro-1,1,2,2-tetrahydrooctyidimethylchlorosilane (30.0 g, 68.1 mmol) and dry diethyl ether (150 mL) are added to a 250 mL round bottom flask equipped with a magnetic stirbar. Diethylamine (17.6 mL, 170 mmol) is added drop wise via syringe. The reaction is stirred at room temperature overnight. The white precipitate is removed via filtration and all volatiles are removed from the resulting solution under high vacuum. The resulting product is filtered a second time through a 0.45 micron syringe filter and transferred to a pre-weighed air tight container and padded with nitrogen. The yield is 32.3 g of N,N-diethyl-1,1-dimethyl-1-(3,3,4,4,5,5,6,6,7,7,8,8,8-tridecafluorooctyl)silylamine, which on a percentage basis is 99.3%.

Example 2 illustrates a method to produce a high yield, high purity, fluorinated silylamine end-cap precursor for endcapping a polyalkylene glycol lubricant.

### Example 3

Dry UCON LB-285 (68.5 g, 67.2 mmol) is weighed into an oven-dried 500 mL round bottom flask equipped with a magnetic stirbar. Dry toluene (100 mL) is added under a nitrogen purge and the reaction is equipped with a 125 mL dropping funnel loaded with a solution of N,N-diethyl-1,1-dimethyl-1-(3,3,4,4,5,5,6,6,7,7,8,8,8-tridecafluorooctyl)silylamine (32.1 g, 67.2 mmol) in dry toluene (50 mL)). The solution of N,N-diethyl-1,1-dimethyl-1-(3,3,4,4,5,5,6,6,7,7,8,8,8-tridecafluorooctyl)silylamine is added drop wise and the reaction is subsequently fitted with a reflux condenser and heated to 80° C. for 15.5 hours. After allowing the reaction to cool to room temperature, all volatiles are removed by rotary evaporation under high vacuum at an elevated temperature. The resulting product is transferred to a pre-weighed air tight container and padded with nitrogen. The yield is 95.0 g of 1,1-dimethyl-1-(3,3,4,4,5,5,6,6,7,7,8,8,8-tridecafluorooctyl)silyl terminated UCON LB-285. On a percentage basis, the yield of end-capped PAG is about 99.3%. The product has a viscosity of 46 cSt@40° C. and a viscosity index of 199.

Example 3 illustrates a method to produce a silyl terminated polyalkylene glycol refrigerant lubricant of higher yield and purity than the process and reagents of Example 1.

### Example 4

UCON RL 897 fluid is provided and is dissolved in chloroform to a concentration of 50% by weight of the total solution. The solution is then dried with molecular sieves and decanted into a round bottom flask fitted with a mechanical stirrer and a reflux condenser. The flask is chilled in an ice bath to provide a source of cooling for controlling the exotherm from the end-capping reaction such that the temperature rise does not exceed 30° C.

An acid scavenger, pyridine, is added to the solution in an amount that is 5% greater than the number of moles of trimethyl silyl chloride that is subsequently added. The trimethyl silyl chloride is added in a dropwise manner to further control the rate of reaction and heat generation. After trimethyl silyl chloride addition, the organic layer is washed three times with an equal volume of water to remove excess pyridine and pyridinium chloride. The organic layer is then dried with anhydrous magnesium sulfate and concentrated via rotary evaporation. Analysis of the UCON RL-897 starting material and the resulting product with 1H-NMR indicates the absence of protons associated with the alcohol terminus of the RL-897 material.

Example 4 illustrates a method of using a hydrocarbyl silyl halide to end-cap a PAG lubricant.

### Example 5

In this example, SYNALOX 100-D95 (available from Dow Chemical Company) is a propylene oxide homopolymer with a molecular weight of 2000 g/mol, an OH functionality of 2 (diol) and kinematic viscosities of 143 cSt at 40° C. and 23 cSt at 100° C. Dry SYNALOX 100-D95 (250 g, 125.0 mmol) is weighed into an oven-dried 1000 mL round bottom flask equipped with a magnetic stirbar. Dry toluene (300 mL) is added under a nitrogen purge and the reaction is equipped with a 250 mL dropping funnel loaded with a solution of trimethylsilyldiethylamine (48.5 mL, 256 mmol) in dry toluene (100 mL). The trimethylsilyldiethylamine solution is added drop wise and the reaction is subsequently fitted with a reflux condenser and heated to 80° C. for 17.5 h. After allowing the reaction to cool to room temperature, all volatiles (toluene, diethylamine, and excess trimethylsilyldiethylamine) are removed by rotary evaporation under high vacuum at an elevated temperature. The resulting product is transferred to a pre-weighed air tight container and padded with nitrogen. The yield is 252 g of trimethylsilyl terminated SYNALOX 100-D95. On a percentage basis, the yield is 94%.

It will be further appreciated that functions or structures of a plurality of components or steps may be combined into a single component or step, or the functions or structures of one-step or component may be split among plural steps or components. The present disclosure contemplates all of these combinations. Unless stated otherwise, dimensions and geometries of the various structures depicted herein are not intended to be restrictive of the disclosure, and other dimensions or geometries are possible. Plural structural components or steps can be provided by a single integrated structure or step. Alternatively, a single integrated structure or step might be divided into separate plural components or steps. In addition, while a feature of the present disclosure may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present disclosure.

The explanations and illustrations presented herein are intended to acquaint others skilled in the art with the disclosure, its principles, and its practical application. Those skilled in the art may adapt and apply the disclosure in its numerous forms, as may be best suited to the requirements of a particular use. Accordingly, the specific embodiments of the present disclosure as set forth are not intended as being exhaustive or limiting. The scope of the disclosure should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

We claim:

1. A silyl-terminated polyalkylene glycol compound that resists water absorption having a number average molecular weight ranging from about 500 to about 4000.

2. The silyl-terminated polyalkylene glycol compound of claim 1 comprising a silyl end group having the formula:
R₁R₂R₃Si—
wherein
R₁, R₂, and R₃ are selected from the group consisting of alkyl, aryl, substituted alkyl, substituted aryl, functionalized alkyl, functionalized aryl, and combinations thereof.

3. The silyl-terminated polyalkylene glycol compound of claim 1 having the formula:
R₅—(O—(PO)ₘ(EO)ₙSiR₁R₂R₃)ₓ
wherein
PO is a propylene oxide unit;
EO is ethylene oxide unit;
R₁, R₂, and R₃ are selected from the group consisting of alkyl, aryl, substituted alkyl, substituted aryl, functionalized alkyl, functionalized aryl, and combinations thereof;
m is a number of at least 0;
n is a number at of least 0;
x is a number of at least 1;
R₅ is an x valent hydrocarbyl group; and
m+n is a number greater than 0.

4. The silyl terminated polyalkylene glycol compound of claim 3, wherein at least one of R₁, R₂ and R₃ is a fluorinated alkyl.

5. The silyl terminated polyalkylene glycol compound of claim 1, wherein said compound has a number average molecular weight of from about 800 to about 2000.

6. The silyl terminated polyalkylene glycol compound of claim 1, wherein at temperatures of from about −40° C. to about 40° C., said compound is miscible in a refrigerant selected from the group consisting of R-134(a), R-152(a), hydrofluoroolefins and mixtures thereof.

7. The silyl terminated polyalkylene glycol compound of claim 1, having a viscosity at about 40° C. of from about 22 cSt to about 220 cSt.

8. A method for preparing a silyl terminated polyalkylene glycol compound comprising reacting a suitable polyalkylene glycol having propylene oxide units with a silyl hydrocarbyl amine in a suitable solvent for a sufficient period of time to produce a silyl terminated polyalkylene glycol.

9. The method of claim 8, wherein the silyl hydrocarbyl amine has the formula:
R₁ R₂R₃SiN(R₄)₂
wherein R₁, R₂, R₃ are selected from the group consisting of alkyl, aryl, substituted alkyl, substituted aryl, functionalized alkyl, functionalized aryl, and combinations thereof; and
R₄ is an alkyl or aryl.

10. The method of preparing a silyl terminated polyalkylene glycol compound of claim 8, wherein said silyl terminated polyalkylene glycol compound has the formula:
R₅—(O—(PO)ₘ(EO)ₙSiR₁R₂R₃)ₓ
wherein
PO is a propylene oxide unit;
EO is an ethylene oxide unit;
R₁, R₂, and R₃ are selected from the group consisting of alkyl, aryl, substituted alkyl, substituted aryl, functionalized alkyl, functionalized aryl, and combinations thereof;
x is a number of at least 1;
R₅ is an x valent hydrocarbyl group;
m is a number greater than 0; and
n is a number of at least 0.

11. The method of preparing a silyl terminated polyalkylene glycol of claim 10, wherein at least one of R₁, R₂, and R₃ is a fluorinated alkyl.

12. The method of preparing a silyl terminated polyalkylene glycol compound of claim 8, wherein said silyl terminated polyakylene glycol lubricant is made according to the reaction: 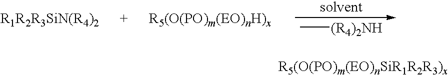
wherein
PO is a propylene oxide unit;
EO is an ethylene oxide unit;
R₁, R₂,R₃ are selected from the group consisting of alkyl, aryl, substituted alkyl, substituted aryl, functionalized alkyl, functionalized aryl, and combinations thereof;
R₄ is an alkyl or an aryl;
x is a number of at least 1;
R₅ is an x valent hydrocarbyl group;
m is a number of at least 0;
n is a number of at least 0;
m+n is greater than 0;
the time sufficient is 12 to 16 hours; and
the temperature is about 80° C.

13. The method of preparing a silyl terminated polyalkylene glycol compound of claim 8, wherein said silyl terminated polyalkylene glycol lubricant has a number average molecular weight of from about 1000 to about 4000.

14. A refrigerant composition, comprising a refrigerant, and a silyl terminated polyalkylene glycol lubricant.

15. The refrigerant composition of claim 14, wherein said silyl terminated polyalkylene glycol lubricant has the formula:
R₅—(O—(PO)ₘ(EO)ₙSiR₁R₂R₃)ₓ
wherein
PO is a propylene oxide unit;
EO is an ethylene oxide unit;
R₁, R₂, and R₃ are selected from the group consisting of alkyl, aryl, substituted alkyl, functionalized alkyl, functionalized aryl, and combinations thereof;
x is a number of at least 1;
R₅ is an x valent hydrocarbyl group;
m is a number of at least 0;
n is a number at of least 0; and
m+n is greater than 0;
wherein said composition has a viscosity in a range of from about 10 to about 460 cSt at 40° C. and said lubricant is miscible in said refrigerant at a temperature range of from about −40° C. to about 40° C.

16. The refrigerant composition of claim 15, wherein at least one of R₁, R₂ and R₃ is a fluorinated alkyl.

17. The refrigeration composition of claim 14, wherein said silyl terminated polyalkylene glycol refrigerant lubricant has a viscosity in a range of from about 22 to about 220 cSt at 40° C.

18. The refrigeration composition of claim 14, wherein said silyl terminated polyalkylene glycol refrigerant lubricant has a number average molecular weight of from about 1000 to about 4000.

19. The refrigeration composition of claim 14, wherein the refrigerant is a hydrofluorocarbon.

20. The refrigeration composition of claim 14, wherein the refrigerant has a GWP of less than about 150.
